(19) United States
(12) Patent Application Publication
(10) Pub. No.: US 2010/0019711 A1
(43) Pub. Date: Jan. 28, 2010

(54) Motor with controllable rotor-pole magnetic intensity

(75) Inventor: Chin-Fa Yen, Taipei County (TW)

Correspondence Address: Chin-Fa Yen, P.O.Box 44-2049, Taipei, 10668, TW

(73) Assignee: ORCHID RADIO CO., LTD.

(21) Appl. No.: 12/219,721

(22) Filed: Jul. 28, 2008

(51) Int. Cl. H02P 25/22; H02K 19/10

(52) U.S. Cl. 318/400.41; 310/210; 318/400.09

(57) ABSTRACT

A motor with a controllable rotor-pole magnetic intensity includes an electromagnetic pole rotor of an electromagnetic coil instead of a magnetic pole rotor composed of permanent magnets. The magnetic intensity variations of the electromagnetic poles of the rotor can be freely and automatically controlled according to input currents or a feedback signal representing a rotating speed of the motor or a load current of the stator so that the torque and the rotating speed of the motor can be changed. This invention has overcome the restriction that the torque and the rotating speed of the motor are restricted by the fixed permanent magnets so that the performance of the motor can be enhanced.

### BACKGROUND OF THE INVENTION

(1) Field of the Invention

The invention relates to a brushless motor structure, and more particularly to a motor, which has a controllable rotor-pole magnetic intensity, can freely change a torque of the motor and freely extend a range of a rotating speed of the motor, and can save the energy.

(2) Description of the Prior Art

The conventional power brushless motors always have the two-phase or three-phase structures, wherein the rotor is composed of permanent super magnets so that the unequilibrium state is formed and the rotor can be rotated when the stator rotates the magnetic field and the torque can be outputted. In a conventional inner rotor type motor, many permanent magnets arranged in the manner of N, S, N, S . . . are disposed on the rotor to form a cylindrical inner rotor, and a cylindrical outer stator with multi-slot coils is arranged outside and corresponding to the rotor. In addition, a rotating shaft penetrates through the inner rotor and the corresponding inner rotor is rotated by the attractive and repellent forces generated by the coils of the outer stator. In the conventional brushless motor, the rotor is composed of permanent super magnets, such as Nd—Fe—B magnets, serving as the magnetic poles of the rotor. Although the torque thereof is large, the rotating speed is restricted within a predetermined range due to the restriction of the permanent super magnets and cannot be increased. Thus, the ranges of the torque and the rotating speed of the motor are always restricted by the permanent super magnets. So, it is difficult to design a motor with the changeable torque and the changeable rotating speed.

The above-mentioned problem that the motor cannot have the optimized ranges of the torque and the rotating speed due to the structure restriction is not overcome so that the application range thereof cannot be further enlarged. So, the prevent inventor has paid attention to the research and development according to the experience, the working principles, the experiments and tests for many years, and thus developed this utility motor with the controllable rotor-pole magnetic intensity. The motor has the large torque at the low rotating speed and can work at the high rotating speed so that the bottleneck in designing the motor is broken through. Thus, the ranges of the torque and the rotating speed of the motor are enlarged to bring advantages to this industry.

### SUMMARY OF THE INVENTION

It is therefore an object of the invention to provide a motor with a controllable rotor-pole magnetic intensity, wherein the magnetic poles composed of permanent magnets are replaced by electromagnetic poles formed by an electromagnetic coil so that a rotor of the motor is formed. In addition, a feedback signal representing the rotating speed of the motor is provided to control the current on the electromagnetic coil of the rotor so that the magnetic intensities of the electromagnetic poles of the rotor can be easily controlled. That is, the output torque and the rotating speed of the motor can be easily controlled so that the ranges of the torque and the rotating speed can be greatly enlarged.

Another object of the invention is to provide a motor with a controllable rotor-pole magnetic intensity, wherein the electric power can be greatly saved without decreasing the torque and the rotating speed.

The invention achieves the above-identified objects by providing a motor with a controllable rotor-pole magnetic intensity. The motor includes a stator, a rotor, two electroconductive rings and two corresponding carbon brushes. The stator has many coils wound in a three-phase input manner. The rotor has many electromagnetic poles formed by an electromagnetic coil. The electromagnetic coil is continuously wound in normal winding manners and reverse winding manners alternately to constitute the rotor having N magnetic poles and S magnetic poles. The N magnetic poles and the S magnetic poles are arranged alternately so that the rotor having N, S, N, S . . . magnetic poles is formed. Each of two carbon brushes is pressed by a spring so that the two carbon brushes are kept in elastic and permanent contact with the electroconductive rings. Thus, the current flowing through the electromagnetic coil of the rotating rotor can be controlled so that the magnetic intensities of the electromagnetic poles can be simultaneously changed. Thus, controlling the current can automatically change the torque and the rotating speed of the motor.

In addition to the controls of the torque and the rotating speed of the motor according to the input current, the torque and the rotating speed of the motor may also be automatically controlled according to a feedback signal representing the rotating speed of the motor or the load current of the stator.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a radially cross-sectional view showing a motor according to a preferred embodiment of the invention.

FIG. 2 is a partially developed view showing the motor according to the preferred embodiment of the invention.

FIG. 3 is an axially cross-sectional view showing the motor according to the preferred embodiment of the invention.

### DETAILED DESCRIPTION OF THE PREFERRED EMBODIMENTS

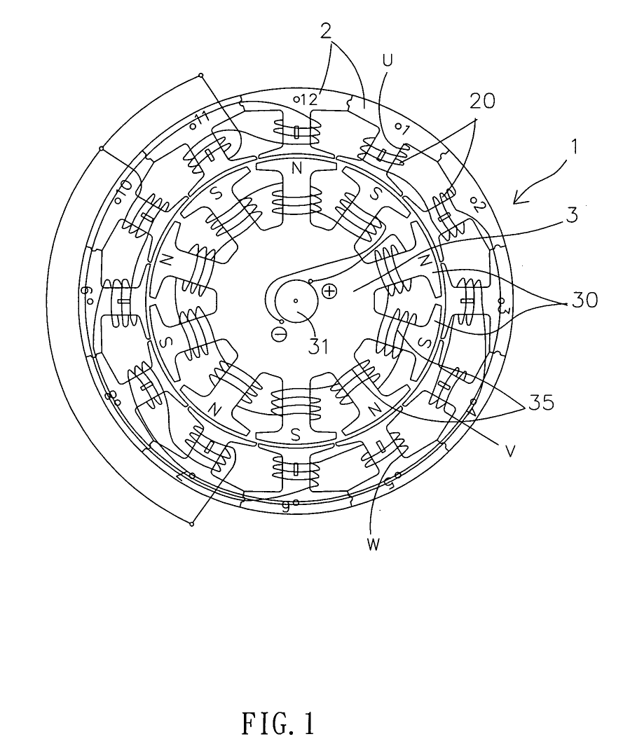

The invention provides a motor with a controllable rotor-pole magnetic intensity. FIG. 1 is a cross-sectional view showing a structure of a three-phase motor 1. The motor 1 includes a stator 2 and a rotor 3. Similar to the conventional three-phase motor, the stator 2 has multiple coils 20. In this invention, the winding of the coils 20 of a 12-slot stator will be illustrated as an example, wherein U, V and W represent three-phase input terminals of the stator. The three-phase winding manners are listed in the following. Regarding the U-phase, the coil is normally wound around o1, reversely wound around o2, jumped to o8, normally wound around o8 and reversely wound around o7, wherein the ends of the coils have the Y connection. Regarding the V-phase, the coil is normally wound around o4, reversely wound around o3, jumped to o9, normally wound around o9 and reversely wound around o10, wherein the ends of the coils have the Y connection. Regarding the W-phase, the coil is normally wound around o5, reversely wound around o6, jumped to o12, normally wound around o12 and reversely wound around o11, wherein the ends of the coils have the Y connection. Thus, the architecture of the three-phase stator is formed. Because the structure and the principle of the portion of the stator 2 are not the key point of the invention, detailed descriptions thereof will be omitted.

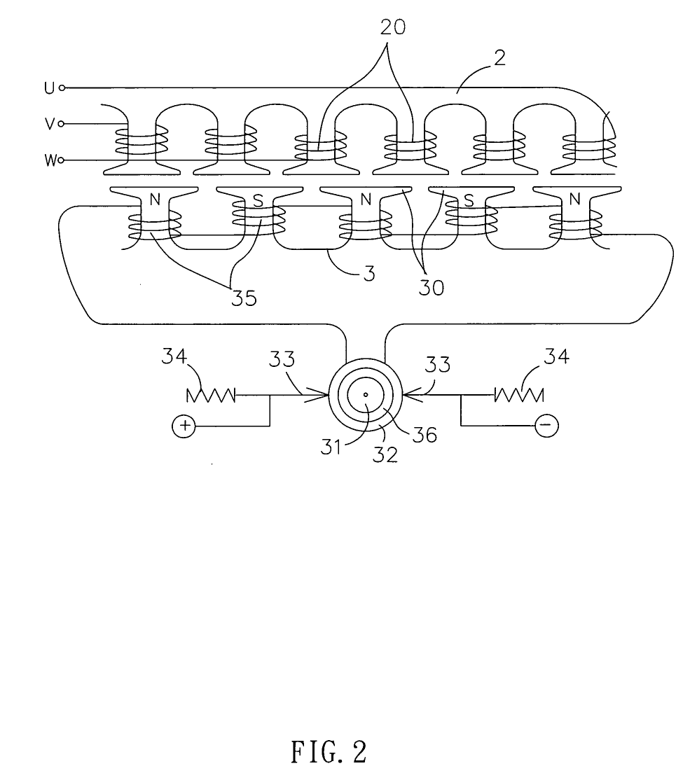

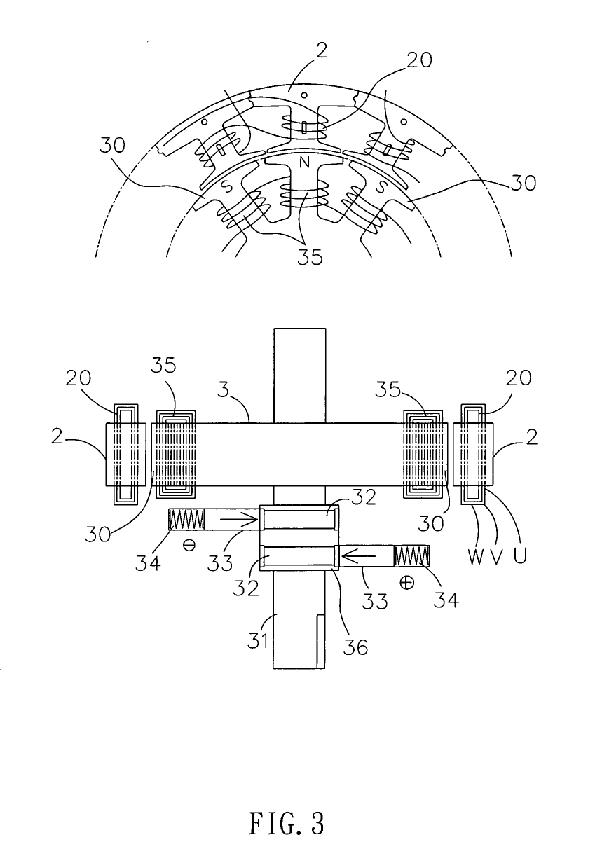

As shown in FIGS. 1 to 3, the rotor 3 has many electromagnetic poles 30 formed by an electromagnetic coil 35. In the example of this invention, the rotor 3 has ten electromagnetic poles 30. In the prior art, the ten poles are composed of permanent super magnets. In this invention, the ten poles are different from those of the prior art. The electromagnetic coil 35 is continuously wound in normal winding manners and reverse winding manners alternately to constitute the rotor 3 having N magnetic poles and S magnetic poles, wherein the N magnetic poles and the S magnetic poles are arranged alternately. For example, N, S, N, S . . . are arranged alternately. A motor shaft 31 has two electroconductive rings 32 and two corresponding carbon brushes 33. Each carbon brush 33 is pressed by a spring 34 so that the two carbon brushes 33 can be kept in elastic and permanent contact with the electroconductive rings 32. Thus, the rotating coil on the electromagnetic coil 35 of the rotor 3 can be controlled by the current so that the magnetic intensities of the electromagnetic poles 30 can be changed simultaneously.

According to the above-mentioned motor 1, after the currents are respectively introduced into the stator 2 and the rotor 3 in practice, all the electromagnetic poles 30 of the rotor 3 naturally and continuously form the N, S, N, S . . . magnetic poles, and repellent or attractive action forces are formed with the N or S magnetic poles of the stator 2 so that the motor 1 is rotated. Then, the N and S magnetic intensities of the electromagnetic poles 30 can be synchronously changed by controlling the current inputted to the electromagnetic coil 35. The torque and the rotating speed of the motor 1 can be controlled according to the change in conjunction with the currents of the coils 20 of the stator 2.

In addition, the magnetic intensities of the electromagnetic poles 30 of the rotor 3 in the motor 1 of the invention can be controlled by controlling the input current as well as by a feedback signal representing the rotating speed of the motor. So, the large torque can be outputted at the low rotating speed, and the small torque can be outputted at the high rotating speed of the motor 1 so that the variation range of the rotating speed of the motor 1 can be enlarged.

As mentioned hereinabove, the variation of the motor 1 of the invention can be automatically controlled according to a feedback signal representing the load current of the stator 2. Thus, the large torque can be outputted at the low rotating speed, and the rotating speed can be freely increased when the light load is detected. At the normal rotating speed, if the heavy load is detected, the magnetizing current of the rotor 3 can be immediately increased to increase the torque against the heavy load so that the torque and the rotating speed of the motor 1 can be freely controlled according to the requirement.

As mentioned hereinabove, the main spirit of the invention is to change the rotor having the permanent magnets as the magnetic poles in the conventional motor into the rotor having electromagnetic poles formed by the electromagnetic coil. So, the magnetic intensity variations of the electromagnetic poles can be freely controlled. In addition, the torque and the rotating speed of the motor can be changed and automatically controlled according to the input currents and the feedback signal representing the rotating speed of the motor or the load current of the stator. This invention has overcome the restriction that the torque and the rotating speed of the motor are restricted by the fixed permanent magnets so that the performance of the motor can be enhanced.

In summary, the motor has the significant effects of freely controlling the torque and the rotation speed.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A motor with a controllable rotor-pole magnetic intensity, the motor comprising:
a stator having a plurality of coils wound in a three-phase input manner; and
a rotor having a plurality of electromagnetic poles formed by an electromagnetic coil, wherein the electromagnetic coil is continuously wound in normal winding manners and reverse winding manners alternately to constitute the rotor having N magnetic poles and S magnetic poles, wherein the N magnetic poles and the S magnetic poles are arranged alternately,
wherein a torque and a rotating speed of the motor are controlled by controlling an input current of the electromagnetic coil of the rotor to synchronously change N and S magnetic intensities of all of the electromagnetic poles of the rotor, and by controlling input currents of the coils of the stator.

2. The motor according to claim 1, wherein rotor further comprises:
two electroconductive rings disposed on a shaft of the motor; and
two corresponding carbon brushes in permanent contact with the electroconductive rings.

3. The motor according to claim 1, wherein magnetic variations of the electromagnetic poles of the rotor are controlled according to a feedback signal representing the rotating speed of the motor.

4. The motor according to claim 1, wherein magnetic variations of the electromagnetic poles of the rotor are controlled according to a feedback signal representing a load current of the stator.

5. The motor according to claim 1, wherein magnetic variations of the electromagnetic poles of the rotor are controlled according to a feedback signal representing the rotating speed of the motor as well as a feedback signal representing a load current of the stator alternately.
